(19) United States
(12) Patent Application Publication
(10) Pub. No.: US 2026/0105198 A1
(43) Pub. Date: Apr. 16, 2026

(54) DEVICE UNLOCKING METHOD AND SYSTEM AND NON-TRANSITORY COMPUTER READABLE STORAGE MEDIUM

(71) Applicant: HTC Corporation, Taoyuan City (TW)

(72) Inventor: Yen-Ting LIU, Taoyuan City (TW)

(21) Appl. No.: 18/912,554

(22) Filed: Oct. 10, 2024

(51) Int. Cl. G06F 21/84; G06F 3/01

(52) U.S. Cl. CPC G06F 21/84; G06F 3/017; G06F 2221/2149

(57) ABSTRACT

The present disclosure provides a device unlocking method and system. The device unlocking method is configured to unlock an electronic device operable by a user, and includes: determining if the user makes a begin hand gesture; displaying an unlocking image having an indicative object with a first appearance when the user makes the begin hand gesture; obtaining a state change from the begin hand gesture, to change the indicative object from the first appearance to a second appearance according to the state change; in response to that the second appearance is substantially the same as a preset appearance, determining if the user makes an end hand gesture; and unlocking the electronic device when the user makes the end hand gesture.

### BACKGROUND

### Field of Invention

This disclosure relates to a method and system, and in particular to a device unlocking method and system.

### Description of Related Art

In some related art of the present disclosure, many people now use personal devices (e.g., mobile phone, tablet, laptop, wearable device, etc.) daily for things such as communication, work, gaming, etc. It should be noted that a locking function is usually inherent in each personal device in order to protect personal information stored in each personal device. In an example that the personal device is a head mounted display for providing a virtual reality environment, if the head mounted display is locked by its owner, someone who wants to operate the head mounted display is required to input a correct password or interact with an accessory device correctly, so as to unlock the head mounted display. These personal devices are rarely unlocked in a manner related to hand gesture. Therefore, a new approach for unlocking the personal device in the manner related to the hand gesture should be proposed.

### SUMMARY

An aspect of present disclosure relates to a device unlocking method. The device unlocking method is configured to unlock an electronic device operable by a user, and includes: determining if the user makes a begin hand gesture; displaying an unlocking image having an indicative object with a first appearance when the user makes the begin hand gesture; obtaining a state change from the begin hand gesture, to change the indicative object from the first appearance to a second appearance according to the state change; in response to that the second appearance is substantially the same as a preset appearance, determining if the user makes an end hand gesture; and unlocking the electronic device when the user makes the end hand gesture.

Another aspect of present disclosure relates to a device unlocking system. The device unlocking system is configured to unlock an electronic device operable by a user, and includes a display panel, a sensor and a processor. The sensor is configured to generate sense data related to a hand movement of the user. The processor is coupled to the sensor and the display, and is configured to: determine if the user makes a begin hand gesture according to the sense data; control the display panel to display an unlocking image having an indicative object with a first appearance when the user makes the begin hand gesture; obtain a state change from the begin hand gesture according to the sense data, to change the indicative object from the first appearance to a second appearance according to the state change by controlling the display panel; in response to that the second appearance is substantially the same as a preset appearance, determine if the user makes an end hand gesture according to the sense data; and unlock the electronic device when the user makes the end hand gesture.

Another aspect of present disclosure relates to a non-transitory computer readable storage medium with a computer program to execute a device unlocking method, wherein the device unlocking method is configured to unlock an electronic device operable by a user, and includes: determining if the user makes a begin hand gesture; displaying an unlocking image having an indicative object with a first appearance when the user makes the begin hand gesture; obtaining a state change from the begin hand gesture, to change the indicative object from the first appearance to a second appearance according to the state change; in response to that the second appearance change is substantially the same as a preset appearance, determining if the user makes an end hand gesture; and unlocking the electronic device when the user makes the end hand gesture.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block diagram of a device unlocking system in accordance with some embodiments of the present disclosure;

FIG. 2 is a schematic diagram of a wearable device operable by a user in a real-world environment in accordance with some embodiments of the present disclosure;

FIG. 3 is a flow diagram of a device unlocking method in accordance with some embodiments of the present disclosure;

FIG. 4A is a schematic diagram of a begin hand gesture in accordance with some embodiments of the present disclosure;

FIG. 4B is a schematic diagram of a state change from the begin hand gesture in accordance with some embodiments of the present disclosure;

FIG. 4C is a schematic diagram of an end hand gesture in accordance with some embodiments of the present disclosure;

FIGS. 5A and 5B are schematic diagrams of an unlocking image in accordance with some embodiments of the present disclosure;

FIG. 6A is a schematic diagram of another begin hand gesture in accordance with some embodiments of the present disclosure;

FIG. 6B is a schematic diagram of another state change from the another begin hand gesture in accordance with some embodiments of the present disclosure;

FIG. 6C is a schematic diagram of another end hand gesture in accordance with some embodiments of the present disclosure; and

FIGS. 7A and 7B are schematic diagrams of another unlocking image in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

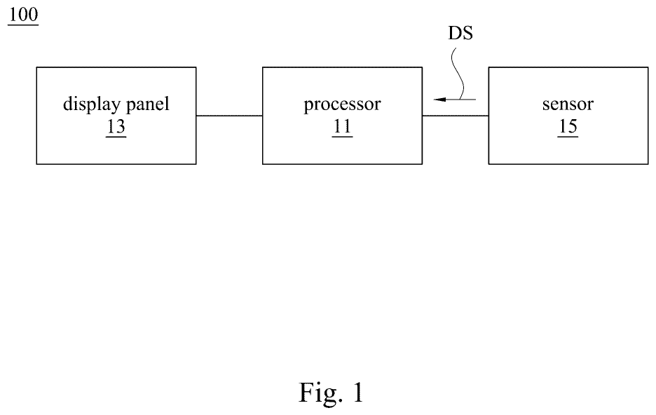

Referring to FIG. 1, FIG. 1 is a block diagram of a device unlocking system 100 in accordance with some embodiments of the present disclosure. In some embodiments, the device unlocking system 100 can be used to unlock an electronic device. As shown in FIG. 1, the device unlocking system 100 includes a processor 11, a display panel 13 and a sensor 15. In particular, the processor 11 is electrically and/or communicatively coupled to the display panel 13 and the sensor 15.

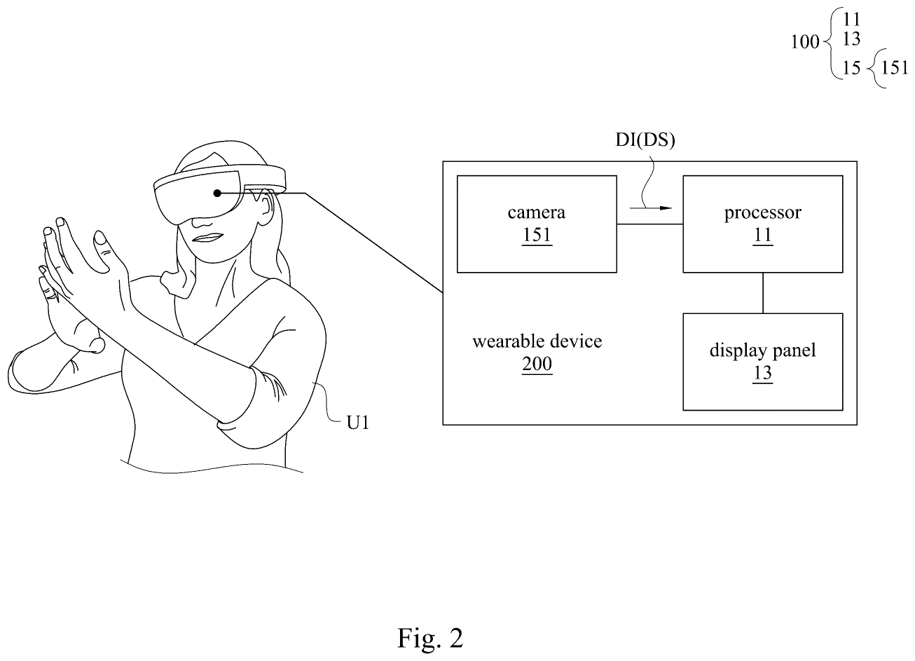

In the embodiments, the electronic device can be operated by an operator (not shown) in a public place (e.g., a park, a library, etc.). It should be understood that the electronic device may be automatically or manually locked to protect its internal information from being accessed, which results in the operator operating the electronic device with limitations at the same time. For example, the operator can only make a communication with the official authority (e.g., police officer) in an emergency. The sensor 15 is configured to sense hand movements of the operator to generate sense data DS. The processor 11 is configured to receive and process the sense data DS to recognize at least one hand gesture made by the operator, and is configured to control the display panel 13 according to a recognition result in order to provide the operator with a visual feedback. Notably, by the visual feedback, the operator can input an unlocking password into the electronic device based on a change in the at least one hand gesture, so as to unlock the electronic device. In some embodiments, the processor 11, the display panel 13, and/or the sensor 15 may be integrated in the electronic device or separated from each other, but is not limited thereto. For example, the processor 11 and the sensor 15 are integrated in the electronic device which may be any private device (e.g., wearable device, handheld device, access control device, etc.) of the operator, and the display panel 13 is implemented with an external display (e.g., flat panel display, head-up display (HUD), etc.) which is separated from the electronic device and is only visible to the operator. The processor 11, the display panel 13 and the sensor 15 would be further described below with reference to some practical applications (as shown in FIG. 2) of the device unlocking system 100.

Referring to FIG. 2, FIG. 2 is a schematic diagram of a wearable device 200 (i.e., the electronic device) operable by a user U1 (i.e., the operator) in a real-world environment (i.e., the public place) in accordance with some embodiments of the present disclosure. In particular, the wearable device 200 is a head mounted display (HMD), and can be worn on the head of the user U1, so as to provide an immersive content for the user U1. However, the present disclosure is not limited thereto.

In some embodiments, the immersive content can be a virtual reality (VR) environment, a mixed reality (MR) environment, or an augmented reality (AR) environment. The virtual reality environment may include the at least one virtual reality object, which cannot be directly seen in the real-world environment by the user U1. The mixed reality environment simulates the real-world environment and enables interaction of the at least one virtual reality object with a simulated real-world environment. The augmented reality environment augments the real-world environment directly seen by the user U1 with the at least one virtual reality object.

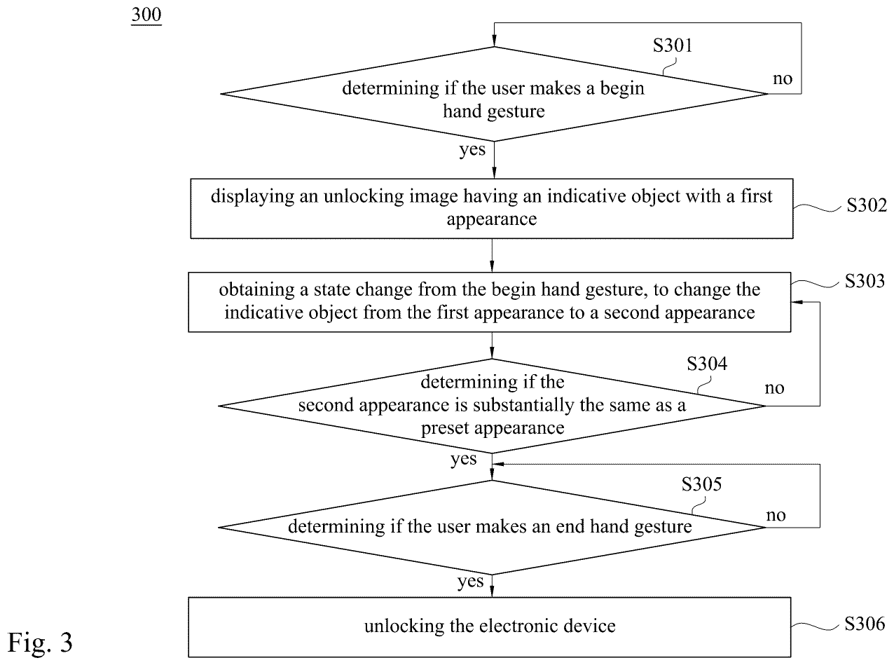

As shown in FIG. 2, the wearable device 200 includes the device unlocking system 100. That is to say, the device unlocking system 100 is applied or integrated to the wearable device 200 in some embodiments, so that the user U1 can unlock the wearable device 200 through the device unlocking system 100 if the wearable device 200 is locked. In the embodiments of FIG. 2, the sensor 15 of the device unlocking system 100 includes a camera 151. The processor 11 is electrically and/or communicatively coupled to the display panel 13 and the camera 151 in the wearable device 200. The operations of the processor 11, the display panel 13 and the camera 151 would be described in detail below with reference to a device unlocking method 300 shown in FIG. 3.

FIG. 3 is a flow diagram of a device unlocking method 300 applicable to the device unlocking system 100 in accordance with some embodiments of the present disclosure. In some embodiments, as shown in FIG. 3, the device unlocking method 300 can be performed with the device unlocking system 100, and includes operations S301-S306. However, the present disclosure should not be limited thereto.

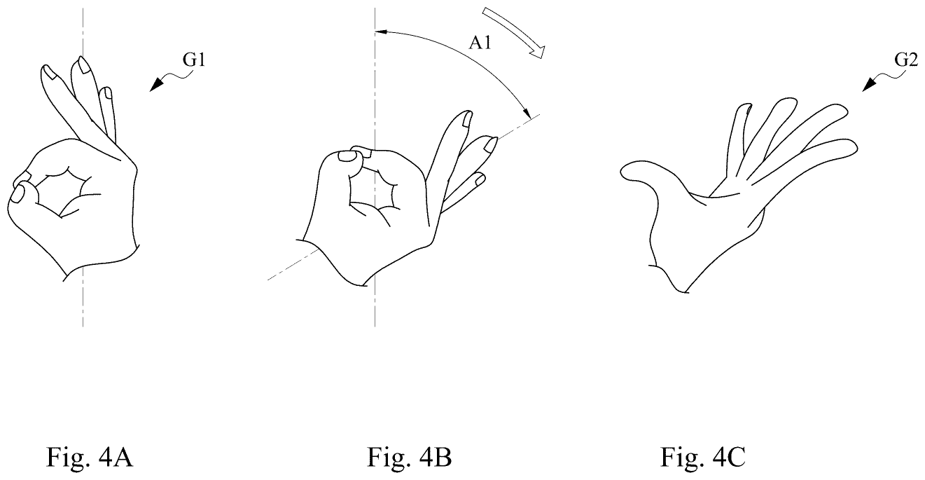

In operation S301, the processor 11 determines if the user U1 makes a begin hand gesture G1. Referring to FIG. 4A, FIG. 4A is a schematic diagram of the begin hand gesture G1 in accordance with some embodiments of the present disclosure. In the embodiments of FIG. 4A, the begin hand gesture G1 is an “OK” gesture, and may be defined by some finger characteristics such as, a fingertip of a thumb being in contact with a fingertip of an index finger, the thumb and the index finger forming a circle, other three fingers (i.e., a middle finger, a ring finger and a little finger) straightening naturally, etc. However, the begin hand gesture G1 of the present disclosure is not limited herein.

In some embodiments, the processor 11 calculates current hand pose data of the user U1 according to the sense data DS generated by the sensor 15, and recognizes a current hand gesture made by the user U1 according to the current hand pose data by utilizing at least one existing approach for gesture recognition. Then, the processor 11 determines if the current hand gesture satisfies the finger characteristics of the begin hand gesture G1, to determine if the user U1 makes the begin hand gesture G1.

In some further embodiments, as shown in FIG. 2, the sense data DS is image data DI of at least one hand of the user. In particular, the camera 151 can generate the image data DI as the sense data DS by capturing multiple images of the at least one hand of the user U1, and transmit the image data DI to the processor 11. Accordingly, the processor 11 can use at least one existing computer vision-based image recognition technology to analyze the image data DI. For example, the processor 11 can detect multiple key points, which are corresponding to multiple landmarks (e.g., fingertip, joint, etc.) of the at least one hand of the user U1, in the image data DI, and estimates the coordinate of each key point in a predefined spatial system whose origin is associated with the position of the wearable device 200 in the real-world environment. The processor 11 can then infer the current hand pose data of the user U1 from the coordinate of each key point.

In some embodiments of operation S301, the processor 11 determines that the user U1 does not make the begin hand gesture G1 when the current hand gesture does not satisfy the finger characteristics of the begin hand gesture G1, so that operation S301 is performed again. When the current hand gesture satisfies the finger characteristics of the begin hand gesture G1, the processor 11 determines that the user U1 makes the begin hand gesture G1. In some further embodiments, the current hand pose data corresponding to this current hand gesture satisfying the finger characteristics of the begin hand gesture G1 is stored by the processor 11 as a begin hand pose data. Accordingly, operation S302 can be performed.

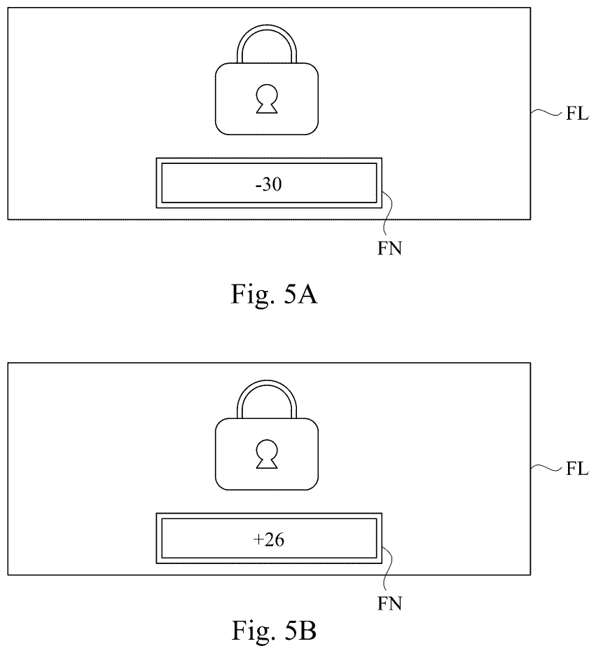

In operation S302, an unlocking image FL having an indicative object with a first appearance is displayed. In some embodiments of operation S302, the processor 11 controls the display panel 13 to display the unlocking image FL in response to a determination that the user U1 makes the begin hand gesture G1. Referring to FIG. 5A, FIG. 5A is a schematic diagram of the unlocking image FL in accordance with some embodiments of the present disclosure. In the embodiments of FIG. 5A, the indicative object is a numeric display field FN, and the first appearance is a numeric value (e.g., “−30” in FIG. 5A) shown on the numeric display field FN, Furthermore, the first appearance is randomly generated by the processor 11 of the device unlocking system 100. That is to say, the numeric value shown on the numeric display field FN can be anyone in a numeric value range. However, the present disclosure should not be limited thereto. For example, in some embodiments, the processor 11 can convert the current hand gesture satisfying the finger characteristics of the begin hand gesture G1 into an initial numeric value by a Hash table or other suitable algorithms, so as to use the initial numeric value as the first appearance. In FIG. 5A, the unlocking image FL further includes a lock pattern above the numeric display field FN, in which this lock pattern may provide a cue for the user U1 to unlock the wearable device 200. From the perspective of the user U1 wearing the wearable device 200, when the user U1 makes the begin hand gesture G1, the unlocking image FL would suddenly appear in the field of view of the user U1.

In some embodiments, as shown in FIG. 2, operation S303 can be performed after the unlocking image FL is displayed. In operation S303, the processor 11 obtain a state change from the begin hand gesture G1, to change the indicative object from the first appearance to a second appearance, which would be described with reference to FIG. 4B and FIG. 5B. FIG. 4B is a schematic diagram of the state change from the begin hand gesture G1 in accordance with some embodiments of the present disclosure. FIG. 5B is a schematic diagram of the unlocking image FL in accordance with some embodiments of the present disclosure.

In some embodiments, referring to FIGS. 4A and 4B together, the user U1 keeps making the begin hand gesture G1, and makes the hand which is used to keep making the begin hand gesture G1 to rotate. Meanwhile, the processor 11 can calculate another current hand pose data of the user U1 according to the sense data DS when the user U1 rotates the hand used to keep making the begin hand gesture G1. Accordingly, in some further embodiments of operation S303, the processor 11 can determine a rotation angle A1 according to this another current hand pose data and the begin hand pose data. For example, the processor 11 may find the rotation angle A1 from a change from the begin hand pose data to this another current hand pose data.

In accordance with the above embodiments, when the state change from the begin hand gesture G1 is obtained, the processor 11 controls the display panel 13 to change the indicative object (e.g., the numeric display field FN) according to the state change from the begin hand gesture G1. Referring to FIGS. 4A and 5A together, the numeric value shown on the numeric display field FN is “−30” (i.e., the first appearance) when the processor 11 detects that the user U1 makes the begin hand gesture G1 for the first time. Referring to FIGS. 4B and 5B together, the numeric value shown on the numeric display field FN becomes “+26” (i.e., the second appearance) when the processor 11 obtains the rotation angle A1 (i.e., the state change from the begin hand gesture G1). In some practical applications, “+26” shown on the numeric display field FN in FIG. 5B means that the user U1 rotates the hand used to keep making the begin hand gesture G1 clockwise by 56 degrees (i.e., the rotation angle A1).

Referring to FIG. 3 again, in some embodiments, operation S304 is performed after the processor 11 obtains the state change from the begin hand gesture G1. In operation S304, the processor 11 determines if the second appearance is substantially the same as a preset appearance.

In accordance with the embodiments that the indicative object is the numeric display field FN, the preset appearance can be a preset password. If the numeric value shown on the numeric display field FN when the processor 11 obtains the state change from the begin hand gesture G1 is substantially the same as the preset password, the processor 11 would determine that the second appearance is substantially the same as the preset appearance in operation S304, so that operation S305 is performed. If the numeric value shown on the numeric display field FN when the processor 11 obtains the state change from the begin hand gesture G1 is not substantially the same as the preset password, the processor 11 would determine that the second appearance is not substantially the same as the preset appearance in operation S304, so that operation S303 and operation S304 are sequentially performed again.

In the above embodiments, the user U1 makes the state change from the begin hand gesture G1 to make the numeric value shown on the numeric display field FN become the preset password. In other words, the user U1 inputs the preset password on the unlocking image FL by making the state change. It should be noted that the preset password is selected from another numeric value range which may be larger than the numeric value range used to generate the first appearance of the indicative object. The numeric value range is defined according to the state change from the begin hand gesture G1. In an example that the state change from the begin hand gesture G1 is the rotation angle A1, the numeric value range is related to a rotation angle range. It should be understood that there will be a maximum rotation angle limited by an individual physical ability. If an individual (e.g., the user U1) is capable of rotating the hand used to keep making the begin hand gesture G1 clockwise or counterclockwise by 360 degrees, a first range limit and a second range limit of the rotation angle range can be determined to be “0” and “+360”, “−180” and “+180”, or “−360” and “+360”, respectively, and can further be used to define of the numeric value range according to the actual usage scenario or user preference. It is noted that “+” and “−” represent a clockwise direction and a counterclockwise direction, respectively, in these embodiments. However, the present disclosure should not be limited thereto. In other embodiments, it can be expressed in the exact opposite way.

In sum of the above descriptions of operation S302-S304, in some embodiments, if the display panel 13 displays the unlocking image FL having the numeric display field FN with the numeric value “+30” (i.e., the first appearance) when the processor 11 determines that the user U1 makes the begin hand gesture G1 and the preset password is the numeric value “−45” (i.e., the preset appearance), the user U1 needs to rotate the hand which is used to keep making the begin hand gesture G1 counterclockwise by 75 degrees, so that the numeric value shown on the numeric display field FN would become “−45” (i.e., the second appearance).

In operation S305, the processor 11 determines if the user U1 makes an end hand gesture G2. Referring to FIG. 4C, FIG. 4C is a schematic diagram of the end hand gesture G2 in accordance with some embodiments of the present disclosure. In the embodiments of FIG. 4C, the end hand gesture G2 is an unnamed gesture which is changed from the “OK” gesture. For example, the user U1, after making the “OK” gesture, can separate apart the thumb and the index finger of the hand used to make the “OK” gesture, so as to form the unnamed gesture. The end hand gesture G2 in FIG. 4C may be defined by some finger characteristics such as, the fingertip of the thumb being not in contact with the fingertip of the index finger, the thumb and the index finger not forming a circle, other three fingers (i.e., the middle finger, the ring finger and the little finger) straightening naturally, etc. It should be understood that the end hand gesture G2 of the present disclosure can be any gesture different from the begin hand gesture G1, and is not limited herein.

It should be noted that the descriptions of operation S305 are simplified herein because the descriptions of operation S305 are similar to those of operation S301. For example, the processor 11 can recognize another current hand gesture made by the user U1 according to the sense data DS, and determine if this another current hand gesture satisfies the finger characteristics of the end hand gesture G2, so as to determine if the user U1 makes the end hand gesture G2.

In some embodiments of operation S305, the processor 11 determines that the user U1 does not make the end hand gesture G2 when the another current hand gesture does not satisfy the finger characteristics of the end hand gesture G2, so that operation S305 is performed again. When the another current hand gesture satisfies the finger characteristics of the end hand gesture G2, the processor 11 determines that the user U1 makes the end hand gesture G2, so that operation S306 is performed.

In operation S306, the processor 11 unlocks the electronic device (e.g., the wearable device 200 in FIG. 2). In some embodiments of operation S306, the processor 11 controls the display panel 13 to stop displaying the unlocking image FL, so that the user U1 can operate the electronic device without restrictions. From the perspective of the user U1 wearing the wearable device 200, the unlocking image FL would suddenly disappear in the field of view of the user U1 when the user U1 makes the end hand gesture G2, and the user U1 can experience the immersive content. In some embodiments of operation S306, before controlling the display panel 13 to stop displaying the unlocking image FL, the processor 11 controls the display panel 13 to show a visual dynamic effect on the unlocking image FL. In particular, the visual dynamic effect is configured to indicate that the wearable device 200 is unlocked. For example, from the perspective of the user U1 wearing the wearable device 200, a U-shaped shackle part of the padlock pattern above the numeric display field FN is lifted, and the unlocking image FL would then disappear.

In some further embodiments of FIG. 3, the processor 11 further determines if the user U1 makes the state change to make the second appearance be substantially the same as the preset appearance within a preset time limitation (e.g., 30 sec), and would determine if the user U1 makes the end hand gesture G2 only when the user U1 makes the state change to make the second appearance be substantially the same as the preset appearance within the preset time limitation. In some embodiments, when the processor 11 starts determining if the user U1 makes the end hand gesture G2, the processor 11 would not consider if the user U1 makes the state change to make the second appearance be substantially the same as the preset appearance. Also, in some embodiments, the processor 11 determines the user U1 makes the end hand gesture G2 by determining that the user U1 keeps making the state change to make the second appearance be substantially the same as the preset appearance for a preset time period (e.g., 1 sec).

It should be understood that the state change from the begin hand gesture G1 is not limited to be the rotation angle A1 as shown in FIG. 4B. For example, the state change from the begin hand gesture G1 can be a displacement. In some embodiments, the user U1, after making the begin hand gesture G1, can move the hand used to keep making the begin hand gesture G1 by a linear distance. During the period that the user U1 moves the hand used to keep making the begin hand gesture G1 by the linear distance, the processor 11 can determine the displacement (which is corresponding to the linear distance) according to a change from the begin hand pose data to current hand pose data, and change the indicative object (e.g., the numeric value shown on the numeric display field FN) from the first appearance to the second appearance according to the displacement (i.e., operation S303). Then, the processor 11 can determine if the second appearance is substantially the same as the preset appearance (i.e., operation S304). In particular, the preset appearance can be the preset password predefined by the user U1 selecting from another numeric value range related to a displacement distance range. This displacement distance range may have a first range limit and a second range limit (e.g., “0” and “+150”, “−75” and “+75”, “−150” and “+150”, “0%” and “+100%”, etc.), which are used to define the numeric value range, according to a maximum linear displacement distance of the hand of an individual (e.g., the user U1). It is noted that “+” and “−” can represent a rightward direction and a leftward direction or an upward direction and a downward direction, respectively, in these embodiments.

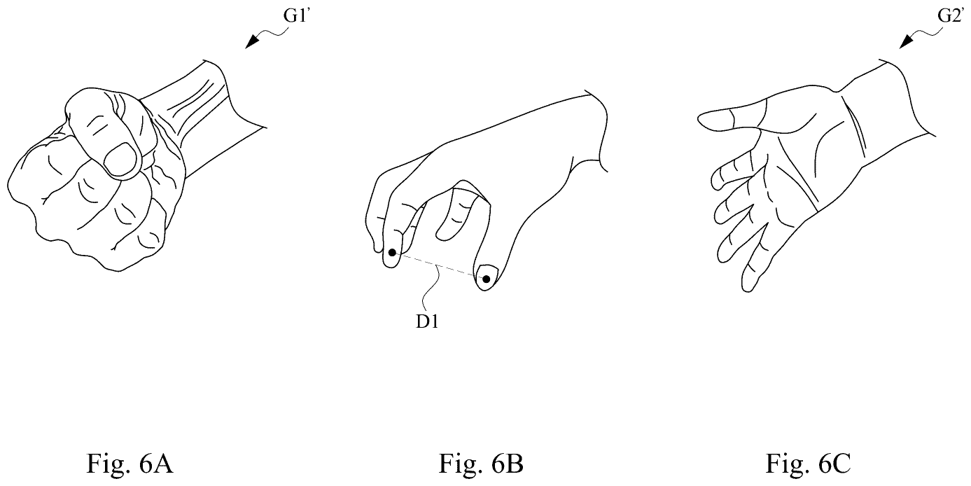

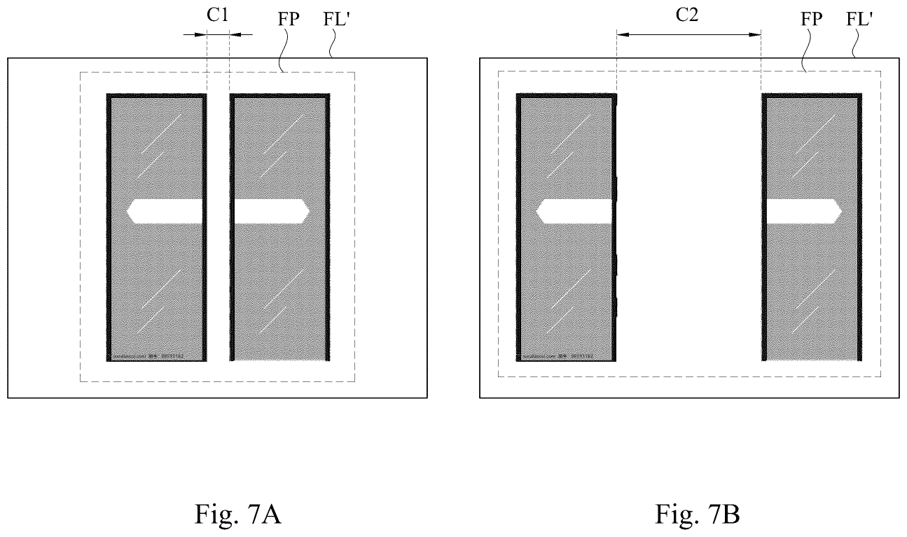

In some embodiments, the state change from the begin hand gesture G1 is a gesture change, which would be described with reference to FIGS. 6A-6C. FIG. 6A is a schematic diagram of another begin hand gesture G1′ in accordance with some embodiments of the present disclosure. FIG. 6B is a schematic diagram of a state change from the begin hand gesture G1′ in accordance with some embodiments of the present disclosure. FIG. 6C is a schematic diagram of another end hand gesture G2′ in accordance with some embodiments of the present disclosure. Also, the indicative object is not limited to the numeric display field FN in FIGS. 5A-5B, and can be a visual pattern in some embodiments, which would be described with reference to FIGS. 7A-7B. FIGS. 7A-7B are schematic diagrams of another unlocking image FL′ in accordance with some embodiments of the present disclosure.

In the embodiments of FIG. 6A, the begin hand gesture G1′ is a “FIST” gesture. In some embodiments, the user U1, after making the “FIST” gesture, gradually (not completely) spreads five fingers of the hand used to make the “FIST” gesture. The descriptions of determining if the user U1 makes the begin hand gesture G1′ are similar to those of operation S301, and therefore are omitted herein. In some embodiments, after the processor 11 determines that the user U1 makes the begin hand gesture G1', the unlocking image FL′ in FIG. 7A is displayed (i.e., operation S302). In the embodiments of FIG. 7A, the unlocking image FL′ includes the visual pattern FP. The visual pattern FP can be implemented with a dynamic door pattern which can be switched between an open status and a close status. In the open status, the dynamic door pattern is separated to have an opening. In the close status, the dynamic door pattern does not have the opening. Furthermore, in FIG. 7A, the opening of the dynamic door pattern would randomly have a width C1 after the processor 11 determines that the user U1 makes the begin hand gesture G1′. Notably, this width C1 can be regarded as a first appearance of the visual pattern FP (i.e., the indicative object).

During the period that the five fingers of the hand used to make the “FIST” gesture are spread gradually, the processor 11 can determine the gesture change according to a change from begin hand pose data (which is calculated when the processor 11 detects that the user U1 makes the begin hand gesture G1′ in FIG. 6A) to current hand pose data, and change the visual pattern FP from the first appearance to a second appearance according to the gesture change (i.e., operation S303). In some further embodiments, the gesture change can be determined according to a distance D1 (as shown in FIG. 6B) between the fingertip of the thumb and the fingertip of the index finger. The distance D1 can be detected according to a change from the begin hand pose data to current hand pose data. It should be understood that the distance D1 should be increased gradually while the five fingers of the hand used to make the “FIST” gesture are spread gradually. At the same time, the opening of the dynamic door pattern becomes wider and wider until the distance D1 is not increased. As a result, in FIG. 7B, the opening of the dynamic door pattern has a width C2 (i.e., the second appearance of the visual pattern FP).

After obtaining the gesture change, the processor 11 determines if the width C2 is substantially the same as a preset width (i.e., operation S304). That is to say, the preset appearance is the preset width in the embodiments of FIGS. 7A-7B. In particular, the preset width can be predefined by the user U1 selecting from yet another numeric value range related to a finger spreading range. This finger spreading range may have a first range limit and a second range limit (e.g., “0” and “+20”, “0%” and “+100%”, etc.), which are used to define the numeric value range, according to a maximum spreading distance of the hand of an individual (e.g., the user U1). It should be understood that the maximum spreading distance may be an average maximum distance between the fingertip of the thumb and the fingertip of the index finger. The processor 11 can compare the width C2 (which may substantially equal a sum of the distance D1 and the width C1) with the preset width, to determine if the second appearance is substantially the same as the preset appearance.

When the width C2 is substantially the same as the preset width, the processor 11 further determines that if the user U2 makes the end hand gesture G2′ (i.e., operation S305), to determine whether to unlock the electronic device. The descriptions of determining if the user U1 makes the end hand gesture G2′ are similar to those of operation S305, and therefore are omitted herein. In FIG. 6C, the end hand gesture G2′ is a “FIVE” gesture. In particular, the “FIVE” gesture can be formed by the user U1 completely spreading the five fingers of the hand used to make the “FIST” gesture. However, the end hand gesture G2′ is not limited herein. In some embodiments, the user U1 can keep the distance D1 (as shown in FIG. 6B) between the fingertip of the thumb and the fingertip of the index finger, and makes the end hand gesture G2′ by lifting the little finger or bending the wrist.

As can be seen from the above embodiments, the state change from the begin hand gesture G1 can include the rotation angle A1, the displacement or the gesture change. The indicative object can be the visual pattern FP or the numeric display field FN. However, the present disclosure is not limited herein. For example, in some embodiments, the indicative object includes both the visual pattern FP and the numeric display field FN. In such cases, the condition (e.g., being rotated clockwise by 26 degrees, being moved leftwards by 74 cm) of the visual pattern FP and the numeric value (e.g., “+26”, “−74”, etc.) shown on the numeric display field FN may be corresponding to each other. Also, the preset appearance can include at least one of the visual pattern with a preset condition (i.e., having the preset width) and the numeric display field with the preset password. For example, referring to FIGS. 5A and 5B together, the lock pattern above the numeric display field FN may be changed in synchronization with the appearance (i.e., the numeric value) of the numeric display field FN, e.g., the lock pattern may be rotated counterclockwise by 30 degrees in FIG. 5A, may be rotated clockwise according to the numeric value changed from “−30” to “+26”, and may be rotated clockwise by 26 degrees in FIG. 5B.

In the above embodiments, the device unlocking system 100 allows the user U1 to set the begin hand gesture G1, the state change detected by the device unlocking system 100, the preset appearance and the end hand gesture G2. In addition, the device unlocking system 100 further allows the user U1 to set at least one of the type of the indicative object (which is corresponding to the state change), the numeric value range used to set the preset appearance, the sampling rate of the sensor 15, the update rate of the indicative object (for example, the condition of the visual pattern FP is updated every specific state change (e.g., 2, 5, 10 degrees, 1 cm, etc.) is detected) and the numeric value range used to generate the first appearance. In other words, the device unlocking system 100 can be customized by the user U1. In such way, the device unlocking system 100 can be prevented from mistakenly detecting, so that the user U1 can have a well user experience.

Furthermore, in the above embodiments of FIGS. 3 and 4A-4C, one set of the begin hand gesture G1, the preset appearance (i.e., the preset password, the preset width, etc.) and the end hand gesture G2 is shown for illustration. However, the present disclosure is not limited thereto. For example, in some further embodiments, the device unlocking system 100 can set multiple sets of the begin hand gesture G1, the preset appearance and the end hand gesture G2 for unlocking the electronic device. Notably, each set can be arranged with a unique begin hand gesture, a unique preset appearance (i.e., a unique password) and a unique end hand gesture. In such arrangements, the complexity of password can be guaranteed.

It should be understood that the configuration of the device unlocking system 100 is not limited to those as shown in FIG. 2. For example, in some embodiments, the camera 151 of the sensor 15 in FIG. 2 is arranged outside the wearable device 200. Also, in some embodiments, the sensor 15 further includes a motion sensor (not shown). In particular, the motion sensor can be mounted on the at least one hand of the user U1, and can be communicatively coupled to the processor 11. Accordingly, the motion sensor can generate motion data (not shown) as the sense data DS by sensing movements of the at least one hand of the user U1, and transmit the motion data to the processor 11. Then, the processor 11 can perform at least one mathematical operation (e.g., orthogonal decomposition, integration, etc.) on the motion data to calculate the current hand pose data. In these embodiments, the motion sensor can be implemented by an inertial measurement unit (IMU) including an accelerometer, a gyroscope and a magnetometer.

In the above embodiments, the processor 11 can be implemented by a central processing unit (CPU), an application-specific integrated circuit (ASIC), a microprocessor, a system on a Chip (SoC) or other suitable processing circuits. The display panel 13 can be implemented by an active matrix organic light emitting diode (AMOLED) display, organic light emitting diode (OLED) display, or other suitable displays.

As can be seen from the above embodiments of the present disclosure, the device unlocking system 100 can be aware that the user U1 has the intention of unlocking the electronic device by detecting that the user U1 makes the begin hand gesture G1. Then, when detecting that the user U1 makes the state change to makes the indicative object have the preset appearance and the end hand gesture G2 sequentially, the device unlocking system 100 would unlock the electronic device for the user U1. That is to say, the device unlocking system 100 allows the user U1 to unlock the electronic device at peak efficiency. It should be noted that the preset appearance can only be accurately made by the user U1 who is only provided with the vision feedback (i.e., the unlocking image FL), which further guarantee the confidentiality of password.

Furthermore, in some related arts of unlocking the electronic device, the electronic device may display a certain screen image, and allow the operator to input a preset pattern or password on the certain screen image. It is noted that the electronic device in the related arts would not generate an initial pattern or numeric value on the certain screen image. Therefore, the operator would make the same movement or action (i.e., drawing the preset pattern, entering the preset password, etc.) each time unlocking the electronic device, which is easy to be memorized or imitated by someone intending to unlock the electronic device without the permission from the operator. In the present disclosure, the device unlocking system 100 would make sure the user U1 makes different movement or action each time unlocking the wearable device 200 (i.e., the electronic device) by providing the unlocking image FL having the indicative object with the different first appearance. In such way, it is difficult for someone intending to unlock the wearable device 200 without the permission from the user U1 to unlock the wearable device 200 by memorizing or imitating.

The disclosed methods, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the at least one processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A device unlocking method, configured to unlock an electronic device operable by a user, and comprising:
determining if the user makes a begin hand gesture;
displaying an unlocking image having an indicative object with a first appearance when the user makes the begin hand gesture;
obtaining a state change from the begin hand gesture, to change the indicative object from the first appearance to a second appearance according to the state change;
in response to that the second appearance is substantially the same as a preset appearance, determining if the user makes an end hand gesture; and
unlocking the electronic device when the user makes the end hand gesture.

2. The device unlocking method of claim 1, wherein the indicative object comprises at least one of a visual pattern and a numeric display field, and the device unlocking method further comprises:
determining if the second appearance is substantially the same as the preset appearance, wherein the preset appearance comprises at least one of the visual pattern with a preset condition and the numeric display field with a preset password.

3. The device unlocking method of claim 1, further comprising:
calculating current hand pose data of the user according to sense data related to at least one hand of the user.

4. The device unlocking method of claim 3, wherein obtaining the state change from the begin hand gesture comprises:
determining a rotation angle according to the current hand pose data and begin hand pose data, wherein the begin hand pose data is calculated when the user makes the begin hand gesture.

5. The device unlocking method of claim 3, wherein obtaining the state change from the begin hand gesture comprises:
determining a displacement according to the current hand pose data and begin hand pose data, wherein the begin hand pose data is calculated when the user makes the begin hand gesture.

6. The device unlocking method of claim 3, wherein obtaining the state change from the begin hand gesture comprises:
determining a gesture change according to the current hand pose data and begin hand pose data, wherein the begin hand pose data is calculated when the user makes the begin hand gesture.

7. The device unlocking method of claim 3, further comprising:
by a camera of the device unlocking system, generating image data of the at least one hand of the user as the sense data.

8. The device unlocking method of claim 3, further comprising:
by a motion sensor of the device unlocking system, generating motion data of the at least one hand of the user as the sense data.

9. The device unlocking method of claim 1, wherein unlocking the electronic device comprises:
stopping displaying the unlocking image.

10. A device unlocking system, configured to unlock an electronic device operable by a user, and comprising:
a display panel;
a sensor, configured to generate sense data related to a hand movement of the user; and
a processor, coupled to the sensor and the display, and configured to:
determine if the user makes a begin hand gesture according to the sense data;
control the display panel to display an unlocking image having an indicative object with a first appearance when the user makes the begin hand gesture;
obtain a state change from the begin hand gesture according to the sense data, to change the indicative object from the first appearance to a second appearance according to the state change by controlling the display panel;
in response to that the second appearance is substantially the same as a preset appearance, determine if the user makes an end hand gesture according to the sense data; and
unlock the electronic device when the user makes the end hand gesture.

11. The device unlocking system of claim 10, wherein the indicative object comprises at least one of a visual pattern and a numeric display field, and the processor is further configured to determine if the second appearance is substantially the same as the preset appearance, wherein the preset appearance comprises at least one of the visual pattern with a preset condition and the numeric display field with a preset password.

12. The device unlocking system of claim 10, wherein the processor is further configured to calculate current hand pose data of the user according to sense data related to at least one hand of the user.

13. The device unlocking system of claim 12, wherein the processor is configured to determine a rotation angle according to the current hand pose data and begin hand pose data, wherein the begin hand pose data is calculated when the user makes the begin hand gesture.

14. The device unlocking system of claim 12, wherein the processor is configured to determine a displacement according to the current hand pose data and begin hand pose data, wherein the begin hand pose data is calculated when the user makes the begin hand gesture.

15. The device unlocking system of claim 12, wherein the processor is configured to determine a gesture change according to the current hand pose data and begin hand pose data, wherein the begin hand pose data is calculated when the user makes the begin hand gesture.

16. The device unlocking system of claim 12, wherein the sensor comprises a camera, and the camera is configured to generate image data of the at least one hand of the user as the sense data.

17. The device unlocking system of claim 12, wherein the sensor comprises a motion sensor, and the motion sensor is configure to generate motion data of the at least one hand of the user as the sense data.

18. The device unlocking system of claim 11, wherein when the user makes the end hand gesture, the processor is configured to control the display panel to stop displaying the unlocking image.

19. The device unlocking system of claim 11, wherein a first range limit and a second range limit are determined according to the state change, and the preset password is selected from a numeric value range defined according to the first range limit and the second range limit.

20. A non-transitory computer readable storage medium with a computer program to execute a device unlocking method, wherein the device unlocking method is configured to unlock an electronic device operable by a user, and comprises:
determining if the user makes a begin hand gesture;
displaying an unlocking image having an indicative object with a first appearance when the user makes the begin hand gesture;
obtaining a state change from the begin hand gesture, to change the indicative object from the first appearance to a second appearance according to the state change;
in response to that the second appearance is substantially the same as a preset appearance, determining if the user makes an end hand gesture; and
unlocking the electronic device when the user makes the end hand gesture.
